(19) United States
(12) Patent Application Publication
(10) Pub. No.: US 2026/0163678 A1
(43) Pub. Date: Jun. 11, 2026

(54) HYBRID AUTOMATIC REPEAT REQUEST FEEDBACK BASED ON QUANTITY AND LOCATION OF CONSECUTIVE BITS

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 18/972,011

(22) Filed: Dec. 6, 2024

(51) Int. Cl. H04L 1/1812; H04L 5/00; H04W 8/22

(52) U.S. Cl. CPC H04L 1/1812; H04L 5/0055; H04W 8/22

(57) ABSTRACT

Various aspects of the present disclosure generally relate to wireless communication. Some aspects more specifically relate to universal lossy compression with fixed length suitable for correlated sources, such as hybrid automatic repeat request acknowledgment (HARQ-ACK) bits. In some aspects, a user equipment (UE) may indicate, to a network node, a quantity and location of consecutive positive acknowledgment bits within the HARQ-ACK bits. The network node may use the indication to identify the consecutive positive acknowledgment bits within the HARQ-ACK bits.

### FIELD OF THE DISCLOSURE

Aspects of the present disclosure generally relate to wireless communication and specifically relate to techniques, apparatuses, and methods associated with hybrid automatic repeat request (HARQ) feedback that includes information regarding a quantity and location of consecutive HARQ bits.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

A user equipment (UE) may transmit hybrid automatic repeat request acknowledgments (HARQ-ACKs) to trigger a network node to perform a retransmission if the UE detects an error with an initial transmission. In some examples, a UE may implement a compression scheme that reduces a quantity of transmitted HARQ-ACK bits. For example, the UE may use a general partitioning scheme to associate k HARQ-ACK bits with a partition index. However, this scheme may require excessive processing resources in order for the UE to identify the partition index, and/or large signaling overhead for signaling partitions for respective values of k and/or respective compression ratios. Additionally or alternatively, the UE may use a bundling scheme by performing a logical AND operation on multiple bits of the k HARQ-ACK bits to “bundle” the k HARQ-ACK bits into a single bit. However, this scheme may ignore a property whereby consecutive same-valued HARQ-ACK bits are likely to occur across different bundles. As a result, the bundling scheme may offer little compression gain in certain examples.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive one or more downlink communications. At least one processor of the one or more processors may be configured to cause the UE to transmit, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit one or more downlink communications. The one or more processors may be configured to cause the network node to receive, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Some aspects described herein relate to a method of wireless communication performed at a UE. The method may include receiving one or more downlink communications. The method may include transmitting, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Some aspects described herein relate to a method of wireless communication performed at a network node. The method may include transmitting one or more downlink communications. The method may include receiving, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Some aspects described herein relate to an apparatus for wireless communication. The apparatus may include means for receiving one or more downlink communications. The apparatus may include means for transmitting, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Some aspects described herein relate to an apparatus for wireless communication. The apparatus may include means for transmitting one or more downlink communications. The apparatus may include means for receiving, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Some aspects described herein relate to a non-transitory computer-readable medium storing a set of instructions for wireless communication. The set of instructions may include one or more instructions that, when executed at a UE, cause the UE to receive one or more downlink communications. The set of instructions may include one or more instructions that, when executed at the UE, cause the UE to transmit, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Some aspects described herein relate to a non-transitory computer-readable medium storing a set of instructions for wireless communication. The set of instructions may include one or more instructions that, when executed at a network node, cause the network node to transmit one or more downlink communications. The set of instructions may include one or more instructions that, when executed at a network node, cause the network node to receive, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating examples of a general framework and signaling for lossy compression of hybrid automatic repeat request (HARQ) acknowledgments, in accordance with the present disclosure.

FIG. 3 is a diagram illustrating an example associated with signaling for HARQ feedback using a quantity and location of consecutive HARQ bits, in accordance with the present disclosure.

FIG. 4 is a diagram illustrating an example associated with a first HARQ feedback compression scheme for providing HARQ feedback using a quantity and location of consecutive HARQ bits, in accordance with the present disclosure.

FIG. 5 is a diagram illustrating an example associated with a second HARQ feedback compression scheme for providing HARQ feedback using a quantity and location of consecutive HARQ bits, in accordance with the present disclosure.

FIG. 6 is a diagram illustrating an example associated with a third HARQ feedback compression scheme for providing HARQ feedback using a quantity and location of consecutive HARQ bits, in accordance with the present disclosure.

FIG. 7 is a diagram illustrating an example associated with a HARQ feedback compression indication, in accordance with the present disclosure.

FIG. 8 is a flowchart illustrating an example process performed, for example, at a UE or an apparatus of a UE that supports HARQ feedback that includes information regarding a quantity and location of consecutive HARQ bits in accordance with the present disclosure.

FIG. 9 is a flowchart illustrating an example process performed, for example, at a network node or an apparatus of a network node that supports HARQ feedback that includes information regarding a quantity and location of consecutive HARQ bits in accordance with the present disclosure.

FIG. 10 is a diagram of an example apparatus for wireless communication that supports HARQ feedback that includes information regarding a quantity and location of consecutive HARQ bits in accordance with the present disclosure.

FIG. 11 is a diagram of an example apparatus for wireless communication that supports HARQ feedback that includes information regarding a quantity and location of consecutive HARQ bits in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Hybrid automatic repeat request (HARQ) is part of a retransmission protocol. The receiver of a transmission (such as a user equipment (UE) receiving a downlink transmission) may check for errors in received data and, if an error is detected, may buffer the received data and request a retransmission from a transmitter of the transmission (such as a network node transmitting the downlink transmission). For example, downlink data may be transmitted on a physical downlink shared channel (PDSCH), and HARQ acknowledgments (ACKs) may be returned on either a physical uplink control channel (PUCCH) or a physical uplink shared channel (PUSCH). The receiver can then combine the buffered data with the retransmitted data prior to channel decoding and error detection, which improves the performance of retransmission.

HARQ feedback regarding a communication may be provided in accordance with a HARQ-ACK codebook (referred to herein as a HARQ codebook). A HARQ codebook defines a format used to signal a set of HARQ-ACK bits to the network node. If the UE transmits HARQ feedback using a format defined by a given HARQ codebook, the UE may be said to transmit the given HARQ codebook.

HARQ-ACK bits may be correlated sources, meaning that consecutive positive acknowledgments (for example, ACKs or 1-bits) or consecutive negative acknowledgments (for example, negative acknowledgments (NACKs) or 0-bits) can occur frequently within a data set of the HARQ-ACK bits. In correlated and non-uniform sources, such as where the probability of a 1-bit (ACK) is much greater than the probability of a 0-bit (NACK), the most common events can be a quantity of consecutive 1-bits, and a less frequent event can be a quantity of consecutive 0-bits; however, transitions from a 0-bit to a 1-bit or transitions from a 1-bit to a 0-bit can be rare in the data set.

In a general partitioning scheme, a UE encodes k HARQ-ACK bits into a group or partition index g, which may result in ┌log₂ G┐ bits after compression, and, thus, a compression ratio of k: ┌log₂ G┐, where G is a total quantity of partition indexes. This scheme may involve high complexity because a network node or the UE may perform an exhaustive search to identify a best partition (for example, group or partition index g). Additionally or alternatively, the general partitioning scheme may involve large signaling overhead due to signaling, from a network node to a UE, of the partition or set of codewords for different lengths k and different compression ratios or values of G. In a bundling scheme, multiple bits of the k bits may be “bundled” into a single bit using a logical AND operation. The bundling scheme may reduce complexity by avoiding exhaustive searches to identify the best partition (at least for large values of k) and signaling overhead; however, the bundling scheme captures only correlations within a given bundle, ignoring source correlation across different bundles. As a result, in certain compression ratio regimes for correlated sources, the bundling scheme may offer limited (if any) compression gain.

Various aspects relate generally to universal lossy compression with fixed length suitable for correlated sources, such as HARQ-ACK bits. “Universal” refers to a scheme or codebook not being a function of a probability distribution of the source (although a performance of the scheme may be a function of the probability distribution). “Fixed length” refers to a compressed output, after source encoding, having a fixed length for a given scheme and a given length of the source, regardless of the realization of the source. Some aspects more specifically relate to a UE indicating, to a network node, a quantity and location of consecutive positive acknowledgment bits (for example, 1-bits) within the HARQ-ACK bits. The network node may use the indication to identify the consecutive positive acknowledgment bits within the HARQ-ACK bits.

In some aspects (for example, in a first HARQ feedback compression scheme), the UE may indicate whether the consecutive positive acknowledgment bits start from a most significant bit (MSB) of the HARQ-ACK bits or a least significant bit (LSB) of the HARQ-ACK bits. For example, the UE may indicate whichever of the MSB or the LSB results in a larger quantity of consecutive positive acknowledgment bits.

In some aspects (for example, in a second HARQ feedback compression scheme), the UE may indicate a first quantity of consecutive positive acknowledgment bits that start from the MSB and a second quantity of consecutive positive acknowledgment bits that start from the LSB.

In some aspects (for example, in a third HARQ feedback compression scheme), the UE may indicate a quantity and location of a longest burst of consecutive positive acknowledgment bits within the HARQ-ACK bits. For example, the longest burst may start and/or end at any bit within the HARQ feedback bit sequence, which may or may not include the MSB and/or the LSB.

In some aspects (for example, in a fourth HARQ feedback compression scheme), the UE may employ a combination of the second and third HARQ feedback compression schemes. For example, the UE may use the second HARQ feedback compression scheme if a sum of the first quantity of consecutive positive acknowledgment bits that start from the MSB and the second quantity of consecutive positive acknowledgment bits that start from the LSB accounts for more total bits than the longest burst of consecutive positive acknowledgment bits, and the UE may use the third HARQ feedback compression scheme if the longest burst of consecutive positive acknowledgment bits includes more bits than the sum of the first quantity of consecutive positive acknowledgment bits that start from the MSB and the second quantity of consecutive positive acknowledgment bits that start from the LSB accounts for.

Particular aspects of the subject matter described in this disclosure can be implemented to realize one or more of the following potential advantages. In some examples, the described techniques can be used to reduce complexity and/or signaling overhead relative to the general partitioning scheme and/or the bundling scheme. For example, the indication of the quantity and location of consecutive positive acknowledgment bits may help to reduce complexity and/or signaling overhead in certain compression ratio regimes for correlated sources.

The first HARQ feedback compression scheme may help to increase a compression ratio of the HARQ-ACK bits with reduced complexity and signaling overhead.

The second HARQ feedback compression scheme may help to reduce information loss, such as in examples where the sum of the first quantity of consecutive positive acknowledgment bits that start from the MSB and the second quantity of consecutive positive acknowledgment bits that start from the LSB includes more total bits than the longest burst of consecutive positive acknowledgment bits.

The third HARQ feedback compression scheme may help to reduce information loss, such as in examples where the longest burst of consecutive positive acknowledgment bits includes more bits than the sum of the first quantity of consecutive positive acknowledgment bits that start from the MSB and the second quantity of consecutive positive acknowledgment bits that start from the LSB.

The fourth HARQ feedback compression scheme may help to further reduce information loss, such as by reducing a probability of an occurrence of an ACK-to-NACK error.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

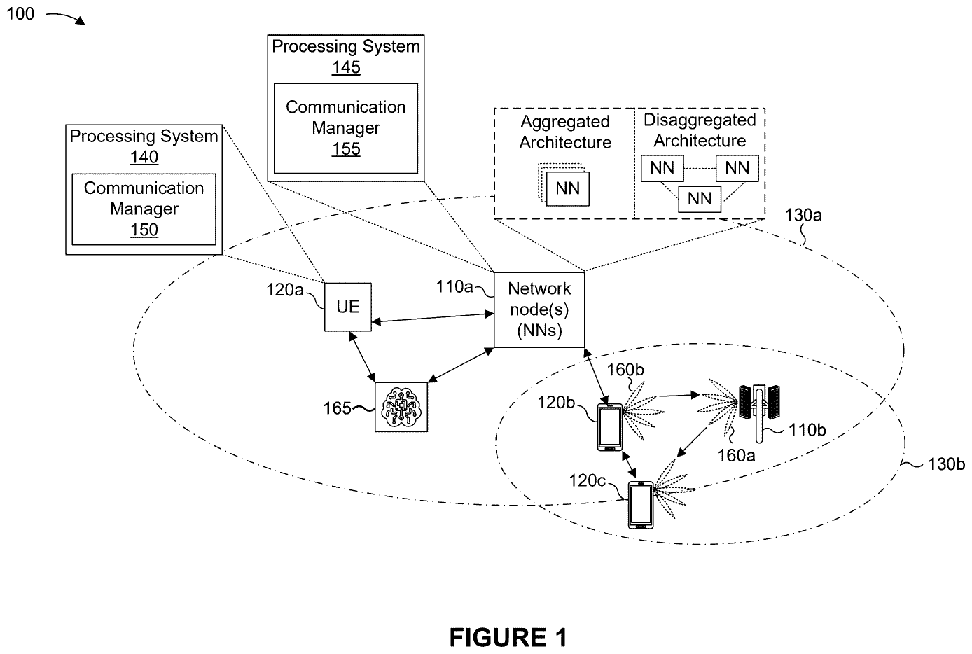

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgment (ACK) indication or a HARQ negative acknowledgment (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive one or more downlink communications; and transmit, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. Additionally or alternatively, the communication manager 150 may perform one or more other operations described herein.

In some aspects, the network node 110 may include a communication manager 155. As described in more detail elsewhere herein, the communication manager 155 may transmit one or more downlink communications; and receive, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. Additionally or alternatively, the communication manager 155 may perform one or more other operations described herein.

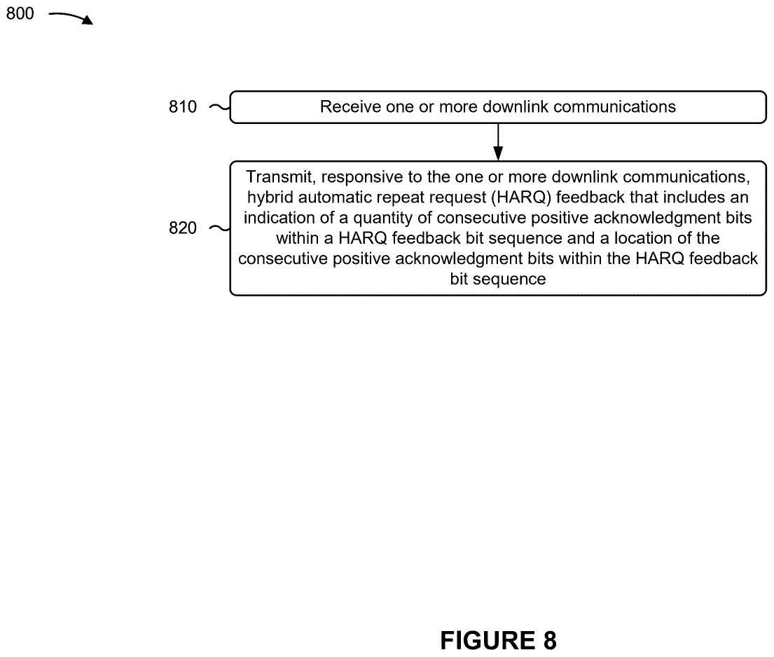

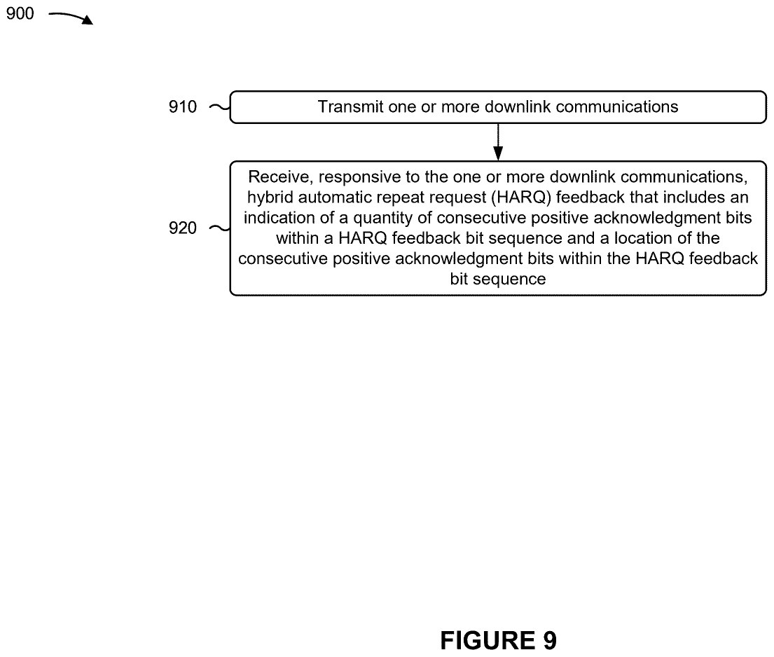

The network node 110, the processing system 145 of the network node 110, the UE 120, the processing system 140 of the UE 120, a CU, a DU, an RU, or any other component(s) of FIG. 1 may implement one or more techniques or perform one or more operations associated with HARQ feedback that includes information regarding a quantity and location of consecutive HARQ bits, as described in more detail elsewhere herein. For example, the processing system 145 of the network node 110, the processing system 140 of the UE 120, a CU, a DU, and/or an RU may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, a CU, a DU, or an RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, a CU, a DU, and/or an RU, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

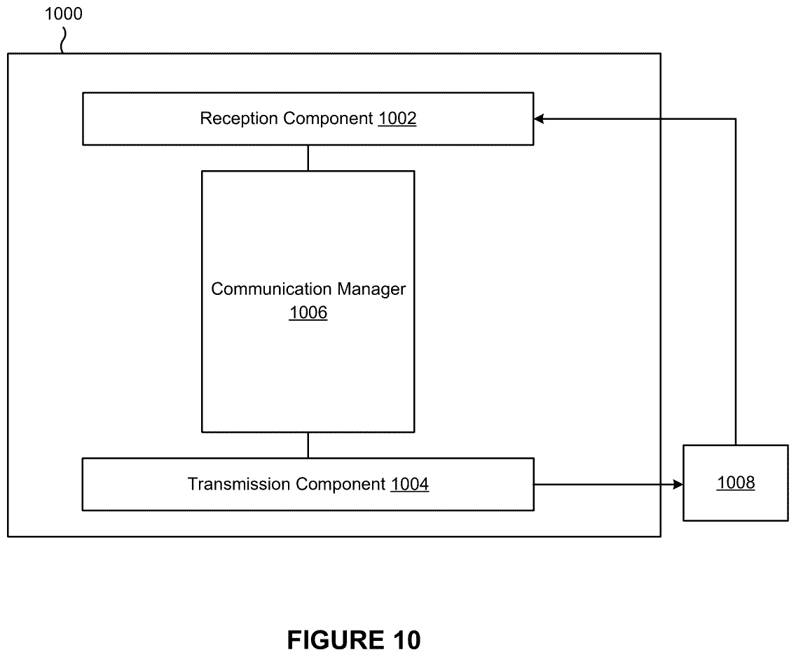

In some aspects, a UE includes means for receiving one or more downlink communications; and/or means for transmitting, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

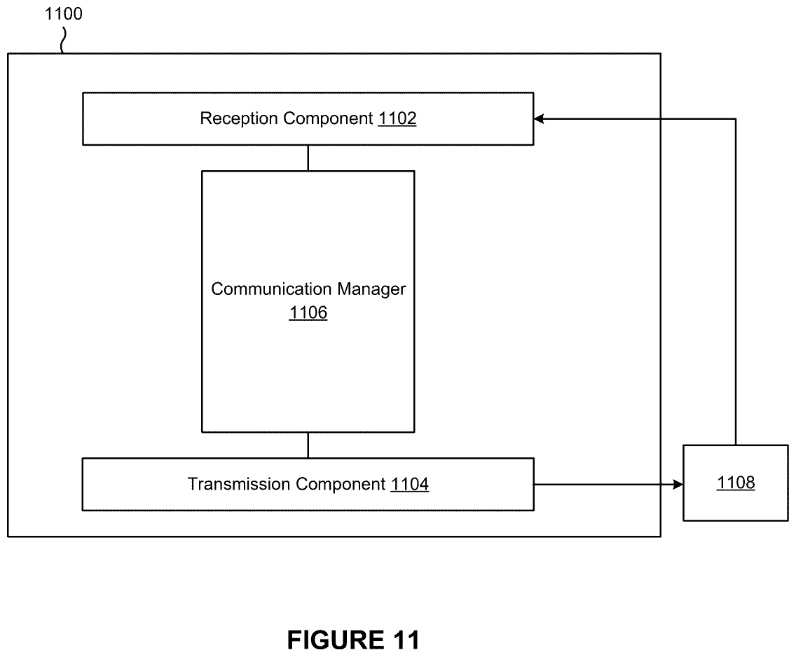

In some aspects, a network node includes means for transmitting one or more downlink communications; and/or means for receiving, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. The means for the network node to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

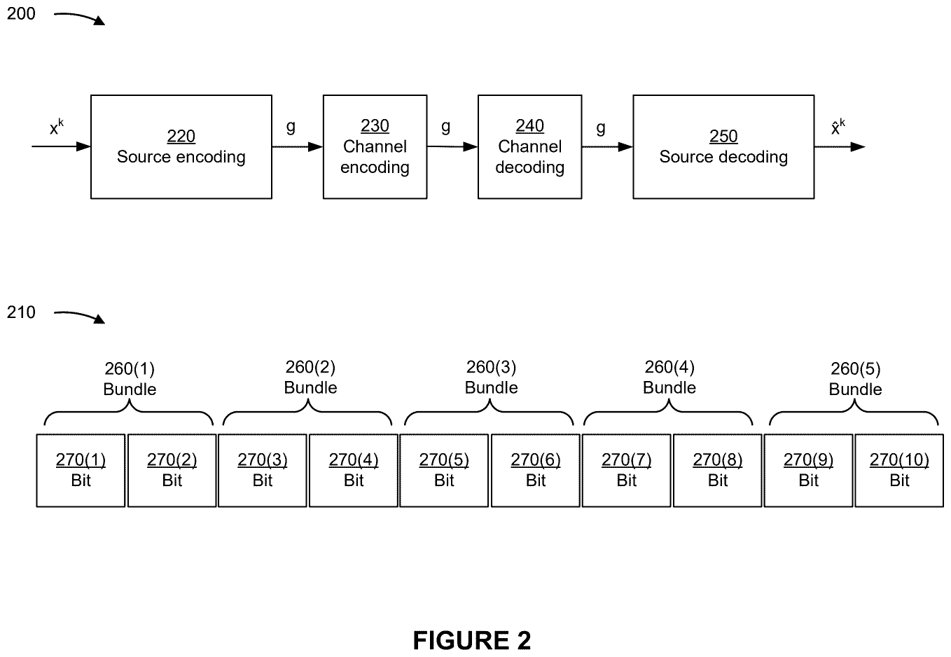

FIG. 2 is a diagram illustrating examples 200 and 210 of a general framework and signaling for lossy compression of HARQ ACKs, in accordance with the present disclosure.

HARQ-ACK codebooks have non-uniform distributions of bits because positive acknowledgments are more likely than NACKs. For example, in an open loop link adaptation that maintains a downlink block error rate (BLER) at 10%, the probability of a given bit being a positive acknowledgment (for example, a “1”) is 0.9, and the probability of a given bit being a NACK (for example, a “0”) is 0.1. This non-uniform probability improves the compressibility of HARQ-ACK codebooks. Moreover, due to channel and/or interference correlation among different PDSCH communications received at different times, frequencies, and/or spatial layers, HARQ-ACK bits may be correlated, which may further improve the compressibility of HARQ-ACK codebooks. Any compression of HARQ-ACK bits should avoid NACK-to-ACK errors where possible because the cost of a NACK-to-ACK error—which may prevent HARQ combining for PDSCHs—may be greater than the cost of an ACK-to-NACK error (which may merely result in unnecessary PDSCH retransmissions).

Example 200 illustrates a general partitioning scheme in which each of the 2^{k} possibilities of a length-k HARQ-ACK codebook (for example, original HARQ-ACK bits of size k) is partitioned into G groups having respective indices g=1, . . . , G. In a first operation 220, the UE 120 may perform source encoding (for example, compression) for k HARQ-ACK bits by encoding the k HARQ-ACK bits into a group or partition index g, which may result in ┌log₂ G┐ bits after compression, and, thus, a compression ratio of k: ┌log₂ G┐. In a second operation 230, the UE 120 may perform channel encoding on the index g. The UE 120 may transmit, and the network node 110 may receive, the index g via a channel. In a third operation 240, the network node 110 may perform channel decoding for the group having the index g. In a fourth operation 250, the network node 110 may perform source decoding (for example, decompression) by selecting a set of codewords (for example, G codewords) of length k: \hat{x}^{k}(g), g=1, . . . , G. The network node 110 may, in accordance with the index g, select the g^{th} codeword \hat{x}^{k}(g). For example, g may be decoded as a codeword corresponding to g: \hat{x}^{k}(g) of length k. The distortion (for example, information loss) in the general partitioning scheme may depend on the partition (for example, the choice of codewords). The partition may be designed such that errors include only ACK-to-NACK errors (that is, no NACK-to-ACK errors). However, the general partitioning scheme may involve high complexity associated with performing an exhaustive search to identify a best partition. Additionally or alternatively, the general partitioning scheme may involve large signaling overhead due to signaling, from the network node 110 to the UE 120, of the partition or set of codewords for different lengths k and different compression ratios or values of G.

Example 210 illustrates a universal lossy compression bundling scheme with a bundle size b, where b impacts the rate-distortion tradeoff. Bundling is a logical AND operation among the b bits, such that multiple bits are “bundled” into a single bit. In example 210, b=2, and the five bundles 260(1)-260(5) of the bits 270(1)-270(10) provide a compression ratio of 10:5. The bundling scheme may reduce complexity by avoiding exhaustive searches to identify the best partition (at least for large values of k) and signaling overhead by allowing the network node 110 to skip signaling, to the UE 120, of the partition or set of codewords for different lengths k and different compression ratios or values of G. Moreover, for non-correlated sources, the bundling scheme can perform at near-optimal levels (at least for small values of k, for which the bundling scheme can be verified numerically by exhaustive search). For correlated sources, the bundling scheme can be even closer to optimal than for non-correlated sources, because the loss of information may decrease as correlation between bits increases. For example, the bundling scheme can be even closer to optimal than for non-correlated sources in examples involving aggressive compression, where the compression ratio is large, the bundle size b is large, the quantity of bundles is small, and/or the quantity of bits after compression is small.

However, the bundling scheme may perform sub-optimally in examples involving non-aggressive compression, where the compression ratio is small, the bundle size b is small, the quantity of bundles is large, and/or the quantity of bits after compression is large. The bundling scheme may be suboptimal in such examples because source correlation across different bundles is ignored; that is, the bundling scheme captures only correlations within a given bundle. For example, the bundling scheme may account for a correlation between bits 270(1) and 270(2) (within bundle 260(1)), but not a correlation between bit 270(1) and any of bits 270(3)-270(10) (between bundle 260(1) and bundles 260(2)-260(5)). As a result, in at least certain compression ratio regimes for correlated sources, the bundling scheme may offer limited (if any) compression gain.

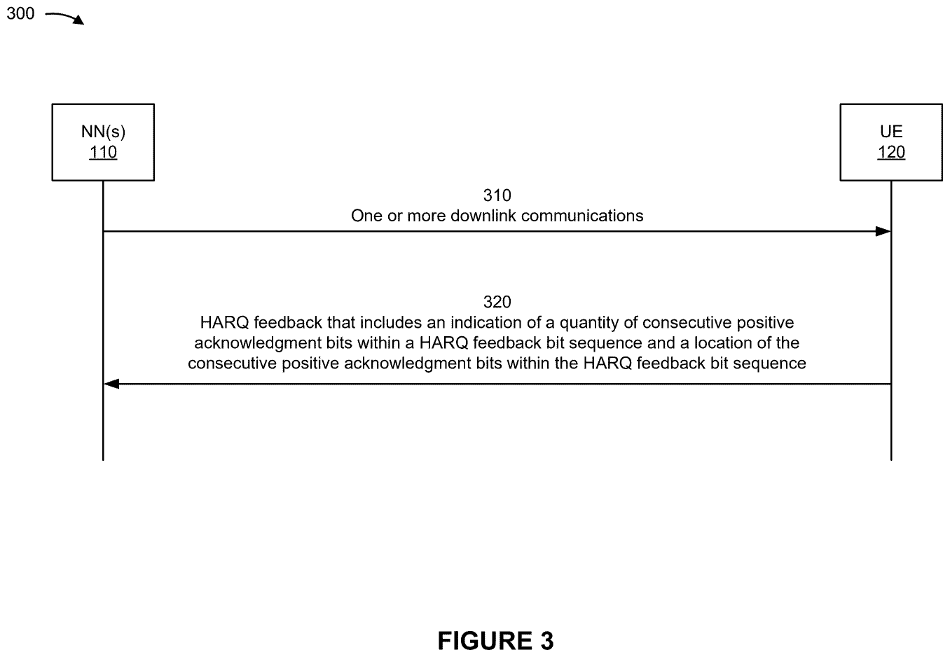

FIG. 3 is a diagram illustrating an example 300 associated with signaling for HARQ feedback using a quantity and location of consecutive HARQ bits, in accordance with the present disclosure. As shown in FIG. 3, a network node 110 and a UE 120 may communicate with one another.

In a first operation 310, the network node 110 may transmit, and the UE 120 may receive, one or more downlink communications. For example, the one or more downlink communications may be carried via a single PDSCH or multiple PDSCHs. In some examples, the UE 120 may generate and/or identify a HARQ feedback bit sequence corresponding to the one or more downlink communications. The HARQ feedback bit sequence may be a bit sequence of a pre-compression HARQ-ACK codebook. For example, bits of the HARQ feedback bit sequence may correspond to the single PDSCH (for example, to different codebooks or codebook groups of the PDSCH) or to the multiple PDSCHs. The HARQ feedback bit sequence may include one or more positive acknowledgment bits and/or one or more negative acknowledgment bits. A positive acknowledgment bit may indicate that the UE 120 successfully decoded certain data conveyed by the one or more downlink communications, and a negative acknowledgment bit may indicate that the UE 120 did not decode certain data conveyed by the one or more downlink communications. For example, a positive acknowledgment bit may have a value of “1,” and a negative acknowledgment bit may have a value of “0.” The terms “ACK” or “HARQ ACK” may be used to refer to only positive acknowledgment bits, or to both positive acknowledgment bits and negative acknowledgment bits. The terms “NACK” or a “NACK bit” may be used to refer to a negative acknowledgment bit.

In a second operation 320, the UE 120 may transmit, and the network node 110 may receive, HARQ feedback responsive to the one or more downlink communications. The HARQ feedback may include an indication of a quantity of consecutive positive acknowledgment bits within the HARQ feedback bit sequence and a location (for example, a position) of the consecutive positive acknowledgment bits within the HARQ feedback bit sequence. For example, the HARQ feedback may indicate a quantity and location of consecutive “1” bits. The network node 110 may identify at least the consecutive positive acknowledgment bits as positive acknowledgment bits. Additionally or alternatively, the network node 110 may interpret one or more bits that are not included in the consecutive positive acknowledgment bits as negative acknowledgment bits. In some examples, the network node 110 may retransmit data corresponding to the bit(s) interpreted as negative acknowledgment bits.

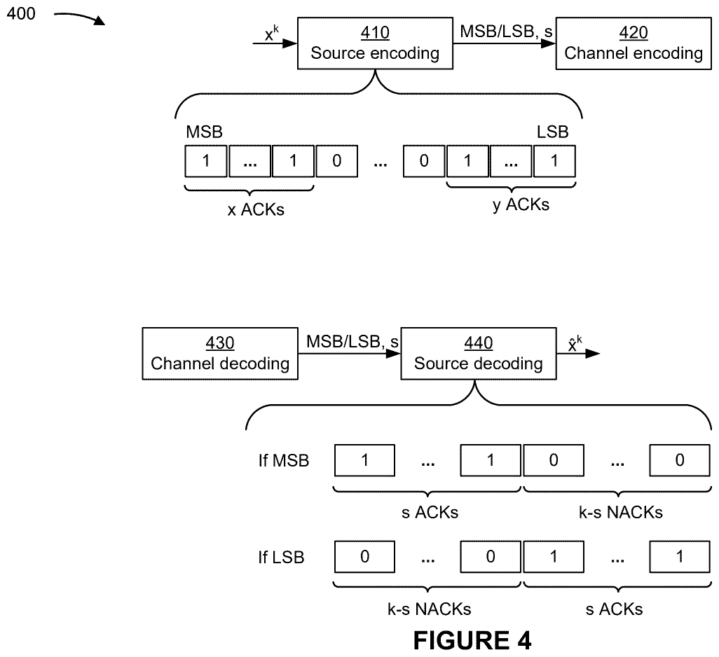

FIG. 4 is a diagram illustrating an example 400 associated with a first HARQ feedback compression scheme for providing HARQ feedback using a quantity and location of consecutive HARQ bits, in accordance with the present disclosure.

In some aspects, the location of the consecutive positive acknowledgment bits may include a most significant bit (MSB) of the HARQ feedback bit sequence or a least significant bit (LSB) of the HARQ feedback bit sequence. For example, the HARQ feedback may indicate whether the consecutive positive acknowledgment bits start from the MSB or the LSB. In other words, the UE 120 may indicate the location of a first negative acknowledgment bit in the HARQ feedback bit sequence relative to the MSB or the LSB, and whether the location of the first negative acknowledgment bit is relative to the MSB or the LSB (the UE 120 may indicate whichever of the MSB or the LSB results in a larger quantity of consecutive positive acknowledgment bits). If both the MSB and the LSB result in the same quantity of consecutive positive acknowledgment bits, then the UE 120 may randomly select one of the MSB or the LSB (or the UE 120 may always select one of the MSB or the LSB in accordance with a fixed rule), because the selection does not impact distortion or ACK-to-NACK error.

In some aspects, the indication of the quantity of the consecutive positive acknowledgment bits and the location of the consecutive positive acknowledgment bits may include a single bit of the HARQ feedback that indicates whether the location of the consecutive positive acknowledgment bits includes the MSB or the LSB. For example, the UE 120 may indicate whether counting for the quantity s of consecutive positive acknowledgment bits starts from the MSB or from the LSB using the single bit. The single bit may be an MSB/LSB indicator of the HARQ feedback, where a first value of the MSB/LSB indicator corresponds to the MSB, and a second value of the MSB/LSB indicator corresponds to the LSB. The value of the MSB/LSB indicator may depend on which of the MSB or the LSB results in a larger quantity of consecutive positive acknowledgment bits.

In some aspects, one or more bits within the HARQ feedback bit sequence that are not included in the consecutive positive acknowledgment bits may be associated with one or more negative acknowledgments. The one or more bits that are not included in the consecutive positive acknowledgment bits may be associated with one or more negative acknowledgments in that the network node 110 may perform source decoding by processing the one or more bits as negative acknowledgment bits. The network node 110 may process the consecutive positive acknowledgment bits as positive acknowledgment bits.

In a first operation 410, the UE 120 may perform source encoding on the HARQ feedback bit sequence. As shown, the HARQ feedback bit sequence may include x consecutive positive acknowledgment bits starting from the MSB and y consecutive positive acknowledgment bits starting from the LSB. In some examples, the x consecutive positive acknowledgment bits and the y consecutive positive acknowledgment bits may be adjacent to respective negative acknowledgment bits, and one or bits between the respective negative acknowledgment bits may be any combination of zero or more positive acknowledgment bits and zero or more negative acknowledgment bits. If x>y, then the UE 120 may indicate (0, s=x), where the first element (“0”) is the MSB/LSB indicator and represents the MSB, and the second element (“s=x”) indicates the value of s. If x<y, then the UE 120 may indicate (1, s=y), where the first element (“1”) is the MSB/LSB indicator and represents the LSB. If 0<x=y<k, then the UE 120 may indicate (0, s=x) or (1, s=x). If x=y=k, then the UE 120 may indicate (s=k), and if x=y=0, then the UE 120 may indicate (s=0); in these latter two examples, the UE 120 may not transmit the MSB/LSB indicator (for example, the indication of the location of the consecutive positive acknowledgment bits may be implicit).

In a second operation 420, the UE 120 may perform channel encoding on the MSB/LSB indicator and s. The UE 120 may transmit, and the network node 110 may receive, an indication of the MSB/LSB indicator and s. In a third operation 430, the network node 110 may perform channel decoding on the MSB/LSB indicator and s. In a fourth operation 440, the network node 110 may perform source decoding on the MSB/LSB indicator and s. For example, if the MSB/LSB indicator indicates that the consecutive positive acknowledgment bits start at the MSB, then the network node 110 may infer that s consecutive positive acknowledgment bits start at the MSB and the remaining k-s bits are negative acknowledgment bits. If the MSB/LSB indicator indicates that the consecutive positive acknowledgment bits start at the LSB, then the network node 110 may infer that s consecutive positive acknowledgment bits start at the LSB and the remaining k-s bits are negative acknowledgment bits.

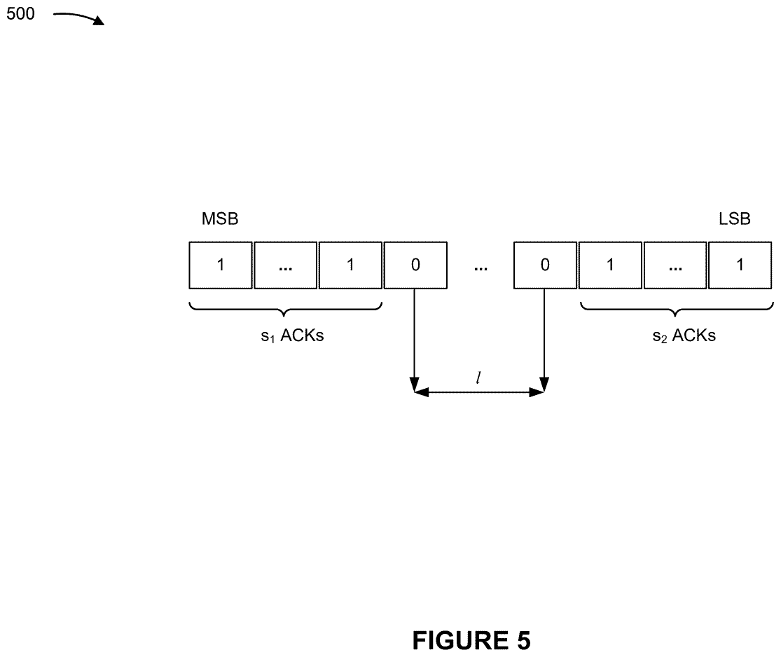

FIG. 5 is a diagram illustrating an example 500 associated with a second HARQ feedback compression scheme for providing HARQ feedback using a quantity and location of consecutive HARQ bits, in accordance with the present disclosure.

In some aspects, the HARQ feedback may include an indication of a first quantity of first consecutive positive acknowledgment bits within the HARQ feedback bit sequence, a first location of the first consecutive positive acknowledgment bits within the HARQ feedback bit sequence that includes a MSB of the HARQ feedback bit sequence, a second quantity of second consecutive positive acknowledgment bits within the HARQ feedback bit sequence, and a second location of the second consecutive positive acknowledgment bits within the HARQ feedback bit sequence that includes a LSB of the HARQ feedback bit sequence. For example, the UE 120 may indicate the first quantity of first consecutive positive acknowledgment bits starting from the MSB and the second quantity of second consecutive positive acknowledgment bits starting from the LSB. The first quantity of first consecutive positive acknowledgment bits and the second quantity of second consecutive positive acknowledgment bits may be denoted by s₁ and s₂, respectively, where s₁ and/or s₂ may be 0.

In some aspects, the indication may be a resource indication value (RIV) that indicates a quantity of intermediate bits between the first consecutive positive acknowledgment bits and the second consecutive positive acknowledgment bits and a location of the intermediate bits (for example, a location of the first intermediate bit). For example, the RIV may indicate (s₁, s₂) and the locations of the first consecutive positive acknowledgment bits and the second consecutive positive acknowledgment bits. For example, as shown, the HARQ feedback bit sequence may include s₁ consecutive positive acknowledgment bits starting from the MSB and s₂ consecutive positive acknowledgment bits starting from the LSB. In some examples, the s₁ consecutive positive acknowledgment bits and the s₂ consecutive positive acknowledgment bits may be adjacent to respective negative acknowledgment bits, and one or bits between the respective negative acknowledgment bits may be any combination of zero or more positive acknowledgment bits and zero or more negative acknowledgment bits. A quantity of bits between the s₁ consecutive positive acknowledgment bits and the s₂ consecutive positive acknowledgment bits may be denoted by length/(for example, l=k−s₁−s₂). In some examples, the RIV may indicate the location of the first negative acknowledgment bit that occurs after the s₁ consecutive positive acknowledgment bits starting from the MSB, and the length/from the first negative acknowledgment bit that occurs after the s₁ consecutive positive acknowledgment bits to the first negative acknowledgment bit that occurs after the s₂ consecutive positive acknowledgment bits from the LSB (or that occurs before the s₂ consecutive positive acknowledgment bits, depending on whether right-to-left ordering or left-to-right ordering of the bits is used). For example, the RIV may be calculated using s₁ and l. If the HARQ feedback bit sequence includes only positive acknowledgment bits, then l=0. The option for l=0 may be added to a first RIV (for example, RIV=0) or to a last RIV (for example, RIV=k*(k+1)/2) as provided in the following pseudocode:

If l = 0, RIV = 0
else If 0 ≤ l − 1 ≤ └k/2┘, RIV = k(l − 1) + s₁ + 1
else, RIV = k(k − l + 1) + (k − 1 − s₁) + 1
Or
If l = 0, RIV = k(k + 1)/2
else If 0 ≤ l − 1 ≤ └k/2┘, RIV = k(l − 1) + s₁
else, RIV = k(k − l + 1) + (k − 1 − s₁)

In some aspects, one or more bits within the HARQ feedback bit sequence that are not included in the first consecutive positive acknowledgment bits or the second consecutive positive acknowledgment bits may be associated with one or more negative acknowledgments. The one or more bits that are not included in the first consecutive positive acknowledgment bits or the second consecutive positive acknowledgment bits may be associated with one or more negative acknowledgments in that the network node 110 may perform source decoding by processing the one or more bits as negative acknowledgment bits. The network node 110 may process the first consecutive positive acknowledgment bits and the second consecutive positive acknowledgment bits as positive acknowledgment bits.

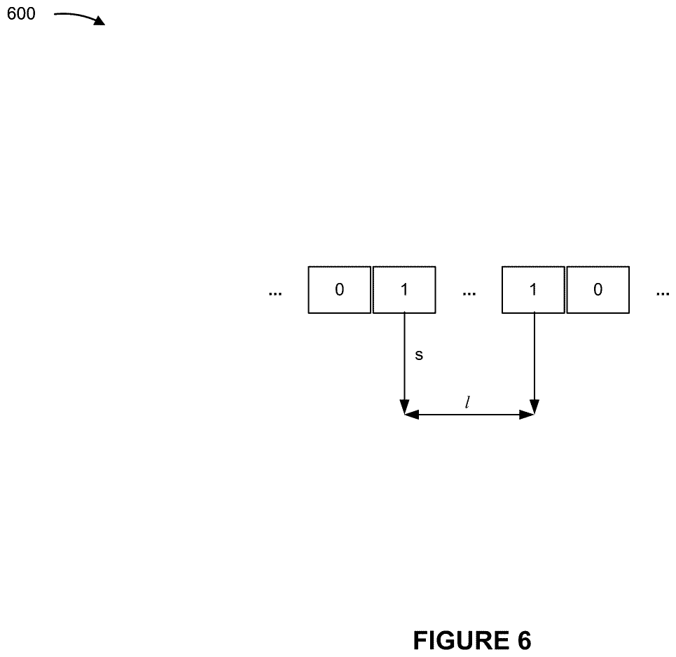

FIG. 6 is a diagram illustrating an example 600 associated with a third HARQ feedback compression scheme for providing HARQ feedback using a quantity and location of consecutive HARQ bits, in accordance with the present disclosure.

In some aspects, the quantity of the consecutive positive acknowledgment bits may be a longest quantity of consecutive positive acknowledgment bits within the HARQ feedback bit sequence. For example, the UE 120 may indicate the location of a longest burst of consecutive positive acknowledgment bits in the HARQ feedback bit sequence. The longest burst may start and/or end anywhere within the HARQ feedback bit sequence. For example, the longest burst may or may not include the MSB, the LSB, and/or one or more intermediate bits between the MSB and the LSB. The location of the longest burst may be denoted as s, and the length of the longest burst (for example, the quantity of consecutive positive acknowledgment bits in the longest burst) may be denoted as l. In some examples, s may equal 0, or s+l may equal k.

In some aspects, the indication may be an RIV that indicates the quantity of the consecutive positive acknowledgment bits and the location of the consecutive positive acknowledgment bits. For example, the RIV may indicate s and l. For example, as shown, the HARQ feedback bit sequence may include a longest burst of s consecutive positive acknowledgment bits. The HARQ feedback bit sequence may also include a negative acknowledgment bit on each side of the longest burst of s consecutive positive acknowledgment bits. Any remaining bits in the HARQ feedback bit sequence may be any combination of zero or more positive acknowledgment bits and zero or more negative acknowledgment bits. The RIV may be calculated using s and l. If the HARQ feedback bit sequence includes only negative acknowledgment bits, then l=0. The option for l=0 may be added to a first RIV (for example, RIV=0) or to a last RIV (for example, RIV=k*(k+1)/2) as provided in the following pseudocode:

If l = 0, RIV = 0
else If 0 ≤ l − 1 ≤ └k/2┘, RIV = k(l − 1) + s + 1
else, RIV = k(k − l + 1) + (k − 1 − s₁) + 1
Or
If l = 0, RIV = k(k + 1)/2
else If 0 ≤ l − 1 ≤ └k/2┘, RIV = k(l − 1) + s
else, RIV = k(k − l + 1) + (k − 1 − s)

In some aspects, one or more bits within the HARQ feedback bit sequence that are not included in the consecutive positive acknowledgment bits may be associated with one or more negative acknowledgments. The one or more bits that are not included in the consecutive positive acknowledgment bits may be associated with one or more negative acknowledgments in that the network node 110 may perform source decoding by processing the one or more bits as negative acknowledgment bits. The network node 110 may process the consecutive positive acknowledgment bits as positive acknowledgment bits.

A fourth HARQ feedback compression scheme for providing HARQ feedback using a quantity and location of consecutive HARQ bits is described as follows. The UE 120 may, using the HARQ feedback bit sequence, identify s₁ and s₂ as discussed above in connection with the second HARQ feedback compression scheme (where s₁ is a quantity of first consecutive positive acknowledgment bits within the HARQ feedback bit sequence having a location that includes the MSB, and s₂ is a quantity of second consecutive positive acknowledgment bits within the HARQ feedback bit sequence having a location that includes the LSB). The UE 120 may, using the HARQ feedback bit sequence, identify/as discussed above in connection with the third HARQ feedback compression scheme (where l is a longest quantity of consecutive positive acknowledgment bits within the HARQ feedback bit sequence). The UE 120 may compare a sum of s₁ and s₂ to l, and, depending on a result of the comparison, transmit the HARQ feedback to the network node 110. For purposes of the following discussion of the fourth HARQ feedback compression scheme, to distinguish between l as used in connection with the second HARQ feedback compression scheme and the third HARQ feedback compression scheme, l indicates the longest quantity of consecutive positive acknowledgment bits as discussed above in connection with the third HARQ feedback compression scheme, and l′ is defined as k-s₁-s₂ for the second HARQ feedback compression scheme.

In some aspects, the HARQ feedback may include an indication of the first quantity s₁ of first consecutive positive acknowledgment bits within the HARQ feedback bit sequence, the first location of the first consecutive positive acknowledgment bits within the HARQ feedback bit sequence that includes the MSB, the second quantity s₂ of second consecutive positive acknowledgment bits within the HARQ feedback bit sequence, and the second location of the second consecutive positive acknowledgment bits within the HARQ feedback bit sequence that includes the LSB. For example, the HARQ feedback may include an indication as described above in connection with the second HARQ feedback compression scheme. In some examples, the HARQ feedback may include the indication as described above in connection with the second HARQ feedback compression scheme in accordance with the sum of the first quantity (s₁) and the second quantity (s₂) being greater than or equal to the longest quantity of consecutive positive acknowledgment bits within the HARQ feedback bit sequence (l). That is, if s₁+s₂≥1, then the UE 120 may use the second HARQ feedback compression scheme to provide the HARQ feedback.

In some aspects, the indication may be an RIV that indicates a quantity of intermediate bits between the first consecutive positive acknowledgment bits and the second consecutive positive acknowledgment bits, and a location of the intermediate bits in accordance with the sum of the first quantity and the second quantity being greater than or equal to the longest quantity of consecutive positive acknowledgment bits. For example, if s₁+s₂≥l, then the UE 120 may use RIV-based signaling as discussed above in connection with the second HARQ feedback compression scheme. For example, the RIV may indicate (s₁, s₂) or, equivalently, (s₁, l′).

In some aspects, one or more bits within the HARQ feedback bit sequence that are not included in the first consecutive positive acknowledgment bits or the second consecutive positive acknowledgment bits may be associated with one or more negative acknowledgments in accordance with the sum of the first quantity and the second quantity being greater than or equal to the longest quantity of consecutive positive acknowledgment bits. For example, if s₁+s₂≥l, then the network node 110 may perform source decoding by processing the one or more bits as negative acknowledgment bits. The network node 110 may process the first consecutive positive acknowledgment bits and the second consecutive positive acknowledgment bits as positive acknowledgment bits.

In some aspects, the quantity of the consecutive positive acknowledgment bits may be the longest quantity of consecutive positive acknowledgment bits/in accordance with/being greater than the sum of s₁ and s₂. For example, if s₁+s₂<l, then the UE 120 may use the third HARQ feedback compression scheme to provide the HARQ feedback. In some examples, the UE 120 may use the third HARQ feedback compression scheme if s>0 and s+l<k. Otherwise, the HARQ feedback may be conveyed via the second HARQ feedback compression scheme because s=0 means that the longest quantity of consecutive positive acknowledgment bits starts from the MSB, and s+1=k means that the longest quantity of consecutive positive acknowledgment bits starts from the LSB.

In some aspects, the indication may be an RIV that indicates the longest quantity of the consecutive positive acknowledgment bits/and the location of the consecutive positive acknowledgment bits in accordance with the longest quantity of consecutive positive acknowledgment bits being greater than the sum of the first quantity and the second quantity. For example, if s₁+s₂<I, then the UE 120 may use RIV-based signaling as discussed above in connection with the third HARQ feedback compression scheme. For example, the RIV may indicate (s,l). In some examples, s−1>0 and s−1+l<k+2. The RIV may be calculated as provided in the following pseudocode:

```
If s₁ + s₂ ≥ l
  If l′ = 0, RIV = k(k + 1)/2
  else If 0 ≤ l′ − 1 ≤ └k/2┘, RIV = k(l′ − 1) + s₁
  else, RIV = k(k − l′ + 1) + (k − 1 − s₁)
else
  If 0 ≤ l − 1 ≤ └(k − 2)/2┘, RIV = (k − 2)(l − 1) + s −1 + k(k + 1)/2 +
1
  else, RIV = (k − 2)(k − 2 − l + 1) + (k − 2 − 1 − (s − 1)) + k(k +
1)/2 + 1
```

In some aspects, one or more bits within the HARQ feedback bit sequence that are not included in the consecutive positive acknowledgment bits may be associated with one or more negative acknowledgments in accordance with the longest quantity of consecutive positive acknowledgment bits being greater than the sum of the first quantity and the second quantity. For example, if s₁+s₂<l, then the network node 110 may perform source decoding by processing the one or more bits as negative acknowledgment bits. The network node 110 may process the consecutive positive acknowledgment bits as positive acknowledgment bits.

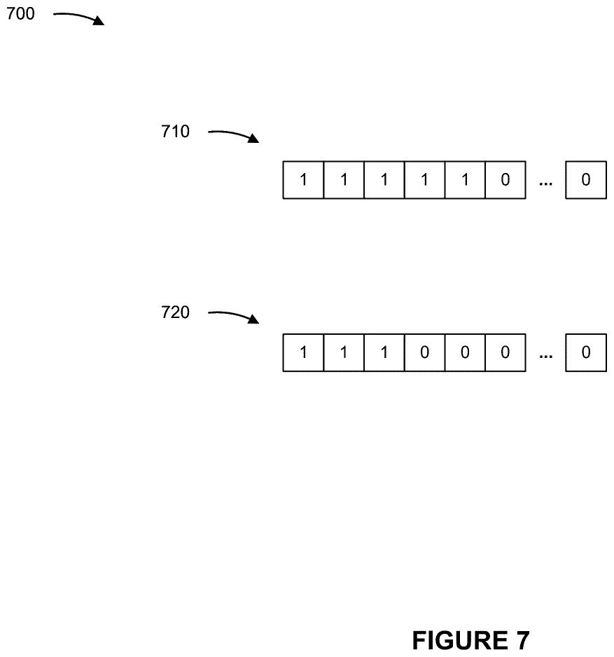

FIG. 7 is a diagram illustrating an example 700 associated with a HARQ feedback compression indication, in accordance with the present disclosure.

In some aspects, the network node 110 may transmit, and the UE 120 may receive, an indication to perform HARQ feedback compression. In some examples, the UE 120 may transmit, and the network node 110 may receive, the HARQ feedback in accordance with the indication to perform HARQ feedback compression (for example, lossy HARQ-ACK compression). The indication to perform HARQ feedback compression may be a semi-static RRC configuration, a MAC-CE activation, or a dynamic indication via DCI, among other examples.

In some aspects, the indication to perform the HARQ feedback compression may include an indication of a HARQ feedback compression scheme. For example, the HARQ feedback compression scheme may be the first HARQ feedback compression scheme, the second HARQ feedback compression scheme, the third HARQ feedback compression scheme, or the fourth HARQ feedback compression scheme. The UE 120 may perform the HARQ feedback in accordance with the indication of the HARQ feedback compression scheme.

In some aspects, the indication to perform the HARQ feedback compression includes an indication of one or more HARQ feedback compression parameters. The one or more HARQ feedback compression parameters may include s as discussed above in connection with the first HARQ feedback compression scheme, s₁ and/or s₂ as discussed above in connection with the second HARQ feedback compression scheme, l as discussed above in connection with the third HARQ feedback compression scheme, and/or s₁, s₂, and l as discussed above in connection with the fourth HARQ feedback compression scheme, among other examples. In some examples, the indication of the one or more HARQ feedback compression parameters may include one or more parameter ranges for each of the first, second, third, and fourth HARQ feedback compression schemes. For example, the indication of the one or more HARQ feedback compression parameters may include a minimum value of s as discussed above in connection with the first HARQ feedback compression scheme, a minimum value of s₁ and/or s₂ as discussed above in connection with the second HARQ feedback compression scheme, a minimum value of l as discussed above in connection with the third HARQ feedback compression scheme, and/or a minimum value of s₁, s₂, and l as discussed above in connection with the fourth HARQ feedback compression scheme, among other examples. If an actual value of a HARQ feedback compression parameter (as identified using the HARQ feedback bit sequence) is less than a corresponding minimum value, then the UE 120 may indicate a value of 0 for that HARQ feedback compression parameter, which may help to avoid NACK-to-ACK errors. For example, in FIG. 7, the indication to perform the HARQ feedback compression may indicate the first HARQ feedback compression scheme and a minimum value for s of 4. In HARQ feedback bit sequence 710, the quantity of consecutive positive acknowledgment bits starting from the MSB is five. Therefore, s=5, and the UE 120 may transmit s=5 because the value of s (5) is greater than the minimum value for s (4). In HARQ feedback bit sequence 720, the quantity of consecutive positive acknowledgment bits starting from the MSB is three. Therefore, s=3, and the UE 120 may transmit s=0 because the value of s (3) is less than the minimum value for s (4).

In some aspects, the UE 120 may transmit, and the network node 110 may receive, an indication of a UE capability of HARQ feedback compression. For example, the indication of the UE capability may indicate that the UE 120 can perform HARQ feedback compression as described herein. In some examples, the indication of the UE capability may specify one or more lossy HARQ-ACK compression schemes (for example, the first, second, third, and/or fourth HARQ feedback compression schemes) that the UE 120 can perform.

The HARQ feedback including the indication of the quantity of the consecutive positive acknowledgment bits and the location of the consecutive positive acknowledgment bits may help to reduce complexity and/or signaling overhead relative to the general partitioning scheme and/or the bundling scheme. For example, the HARQ feedback may help to reduce complexity and/or signaling overhead in at least certain compression ratio regimes for correlated sources, such as in examples involving non-aggressive compression.

The location of the consecutive positive acknowledgment bits including a MSB of the HARQ feedback bit sequence or a LSB of the HARQ feedback bit sequence may help to increase compression ratios with reduced signaling overhead. For example, a quantity of bits used after source encoding may be 1+log₂ k, resulting in a compression ratio of k: 1+log₂ k. The quantity of bits used after source encoding may be 1+log₂ k for the following reasons. s may be equal to 0,1,2, . . . ,k, and counting may start from the MSB or the LSB. However, for s=0 and s=k, whether counting starts from the MSB or the LSB may be immaterial. In examples where s=0, the source decoder may assume that the HARQ feedback bit sequence is all NACKs, which may help to avoid NACK-to-ACK errors. In examples where s=k, the source decoder may assume that the HARQ feedback bit sequence is all ACKs. Hence, there are 2(k+1)−2=2k choices, resulting in 1+log₂ k bits.

The HARQ feedback including the indication of the first quantity of first consecutive positive acknowledgment bits, the first location of the first consecutive positive acknowledgment bits, the second quantity of second consecutive positive acknowledgment bits, and the second location of the second consecutive positive acknowledgment bits may help to use high compression ratios to reduce information loss in at least some examples. For example, a quantity of bits used after source encoding may be

$${log}_{2} ( ( \begin{matrix}k + 1 \\ 2\end{matrix} ) + 1 ) ,$$

resulting in a compression ratio of k:

$${log}_{2} ( 1 + ( \begin{matrix}k + 1 \\ 2\end{matrix} ) ) .$$

The compression ratio may be k:

$${log}_{2} ( 1 + ( \begin{matrix}k + 1 \\ 2\end{matrix} ) )$$

because s₁+s₂ k, and a quantity of possibilities may be calculated as

$$1 + ( \begin{matrix}k + 1 \\ 2\end{matrix} ) .$$

The quantity of the consecutive positive acknowledgment bits being a longest quantity of consecutive positive acknowledgment bits within the HARQ feedback bit sequence may enable use of high compression ratios to reduce information loss in at least some examples. For example, a quantity of bits used after source encoding may be

$${log}_{2} ( 1 + ( \begin{matrix}k + 1 \\ 2\end{matrix} ) ) ,$$

resulting in a compression ratio of k:

$${log}_{2} ( 1 + ( \begin{matrix}k + 1 \\ 2\end{matrix} ) ) .$$

The compression ratio may be k:

$${log}_{2} ( 1 + ( \begin{matrix}k + 1 \\ 2\end{matrix} ) )$$

because a quantity of possibilities may be calculated as

$$1 + ( \begin{matrix}k + 1 \\ 2\end{matrix} )$$

(using a different encoding than the second HARQ feedback compression scheme).

The indication being in accordance with the sum of the first quantity and the second quantity being greater than or equal to the longest quantity of consecutive positive acknowledgment bits, and/or the quantity of the consecutive positive acknowledgment bits in accordance with the longest quantity of consecutive positive acknowledgment bits being greater than the sum of the first quantity and the second quantity, may help to reduce the probability of an ACK-to-NACK error. For example, the fourth HARQ feedback compression scheme may combine the second HARQ feedback compression scheme, which may involve

$$1 + ( \begin{matrix}k + 1 \\ 2\end{matrix} )$$

possibilities, as discussed above, and the third HARQ feedback compression scheme, which may involve

$$( \begin{matrix}k - 1 \\ 2\end{matrix} )$$

possibilities in examples where s>0 and s+l<k. Restricting the third HARQ feedback compression scheme to examples where s>0 and s+l<k may remove possibilities of the first HARQ feedback compression scheme-which are already reported in the second HARQ feedback compression scheme in examples where s₁+s₂≥l—from those of the third HARQ feedback compression scheme, resulting in the

$$( \begin{matrix}k - 1 \\ 2\end{matrix} )$$

possibilities. Therefore, the fourth HARQ feedback compression scheme may have a total of

$$1 + ( \begin{matrix}k + 1 \\ 2\end{matrix} ) + ( \begin{matrix}k - 1 \\ 2\end{matrix} )$$

possibilities. A quantity of bits used after source encoding may be

$${log}_{2} ( 1 + ( \begin{matrix}k + 1 \\ 2\end{matrix} ) + ( \begin{matrix}k - 1 \\ 2\end{matrix} ) ) ,$$

resulting in a compression ratio of k:

$${log}_{2} ( 1 + ( \begin{matrix}k + 1 \\ 2\end{matrix} ) + ( \begin{matrix}k - 1 \\ 2\end{matrix} ) ) .$$

One or more bits that are not included in consecutive positive acknowledgment bits being associated with one or more negative acknowledgments may help to avoid NACK-to-ACK errors.

The indication to perform the HARQ feedback compression including an indication of one or more HARQ feedback compression parameters may help to enable granular control of the compression ratio. For example, the indication may enable the network node 110 to control a tradeoff between a quantity of bits that are used after compression for a given scheme and a quantity of errors that occur due to the compression.

FIG. 8 is a flowchart illustrating an example process 800 performed, for example, at a UE or an apparatus of a UE that supports HARQ feedback that includes information regarding a quantity and location of consecutive HARQ bits in accordance with the present disclosure. Example process 800 is an example where the apparatus or the UE (for example, UE 120) performs operations associated with HARQ feedback that includes information regarding a quantity and location of consecutive HARQ bits.

As shown in FIG. 8, in some aspects, process 800 may include receiving one or more downlink communications (block 810). For example, the UE (such as by using communication manager 150 or reception component 1002, depicted in FIG. 10) may receive one or more downlink communications, as described above.

As further shown in FIG. 8, in some aspects, process 800 may include transmitting, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence (block 820). For example, the UE (such as by using communication manager 150 or transmission component 1004, depicted in FIG. 10) may transmit, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence, as described above.

Process 800 may include additional aspects, such as any single aspect or any combination of aspects described below or in connection with one or more other processes described elsewhere herein.

In a first additional aspect, the location of the consecutive positive acknowledgment bits includes a MSB of the HARQ feedback bit sequence or a LSB of the HARQ feedback bit sequence.

In a second additional aspect, alone or in combination with the first aspect, the indication of the quantity of the consecutive positive acknowledgment bits and the location of the consecutive positive acknowledgment bits includes a single bit of the HARQ feedback that indicates whether the location of the consecutive positive acknowledgment bits includes the MSB or the LSB.

In a third additional aspect, alone or in combination with one or more of the first and second aspects, one or more bits within the HARQ feedback bit sequence that are not included in the consecutive positive acknowledgment bits are associated with one or more negative acknowledgments.

In a fourth additional aspect, alone or in combination with one or more of the first through third aspects, the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a MSB of the HARQ feedback bit sequence, and the indication is further of a second quantity of second consecutive positive acknowledgment bits within the HARQ feedback bit sequence and a second location of the second consecutive positive acknowledgment bits within the HARQ feedback bit sequence that includes a LSB of the HARQ feedback bit sequence.

In a fifth additional aspect, alone or in combination with one or more of the first through fourth aspects, the indication is an RIV that indicates a quantity of intermediate bits between the first consecutive positive acknowledgment bits and the second consecutive positive acknowledgment bits and a location of the intermediate bits.

In a sixth additional aspect, alone or in combination with one or more of the first through fifth aspects, one or more bits within the HARQ feedback bit sequence that are not included in the first consecutive positive acknowledgment bits or the second consecutive positive acknowledgment bits are associated with one or more negative acknowledgments.

In a seventh additional aspect, alone or in combination with one or more of the first through sixth aspects, the quantity of the consecutive positive acknowledgment bits is a longest quantity of consecutive positive acknowledgment bits within the HARQ feedback bit sequence.

In an eighth additional aspect, alone or in combination with one or more of the first through seventh aspects, the indication is an RIV that indicates the quantity of the consecutive positive acknowledgment bits and the location of the consecutive positive acknowledgment bits.

In a ninth additional aspect, alone or in combination with one or more of the first through eighth aspects, one or more bits within the HARQ feedback bit sequence that are not included in the consecutive positive acknowledgment bits are associated with one or more negative acknowledgments.

In a tenth additional aspect, alone or in combination with one or more of the first through ninth aspects, the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a MSB of the HARQ feedback bit sequence, and the indication is further of a second quantity of second consecutive positive acknowledgment bits within the HARQ feedback bit sequence and a second location of the second consecutive positive acknowledgment bits within the HARQ feedback bit sequence that includes a LSB of the HARQ feedback bit sequence, in accordance with a sum of the first quantity and the second quantity being greater than or equal to a longest quantity of consecutive positive acknowledgment bits within the HARQ feedback bit sequence.

In an eleventh additional aspect, alone or in combination with one or more of the first through tenth aspects, the indication is an RIV that indicates a quantity of intermediate bits between the first consecutive positive acknowledgment bits and the second consecutive positive acknowledgment bits, and a location of the intermediate bits in accordance with the sum of the first quantity and the second quantity being greater than or equal to the longest quantity of consecutive positive acknowledgment bits.

In a twelfth additional aspect, alone or in combination with one or more of the first through eleventh aspects, one or more bits within the HARQ feedback bit sequence that are not included in the first consecutive positive acknowledgment bits or the second consecutive positive acknowledgment bits are associated with one or more negative acknowledgments in accordance with the sum of the first quantity and the second quantity being greater than or equal to the longest quantity of consecutive positive acknowledgment bits.

In a thirteenth additional aspect, alone or in combination with one or more of the first through twelfth aspects, the quantity of the consecutive positive acknowledgment bits is a longest quantity of consecutive positive acknowledgment bits in accordance with the longest quantity of consecutive positive acknowledgment bits within the HARQ feedback bit sequence being greater than a sum of a first quantity of first consecutive positive acknowledgment bits within the HARQ feedback bit sequence having a location including a MSB of the HARQ feedback bit sequence and a second quantity of second consecutive positive acknowledgment bits within the HARQ feedback bit sequence having a location including a LSB of the HARQ feedback bit sequence.

In a fourteenth additional aspect, alone or in combination with one or more of the first through thirteenth aspects, the indication is an RIV that indicates the longest quantity of the consecutive positive acknowledgment bits and the location of the consecutive positive acknowledgment bits in accordance with the longest quantity of consecutive positive acknowledgment bits being greater than the sum of the first quantity and the second quantity.

In a fifteenth additional aspect, alone or in combination with one or more of the first through fourteenth aspects, one or more bits within the HARQ feedback bit sequence that are not included in the consecutive positive acknowledgment bits are associated with one or more negative acknowledgments in accordance with the longest quantity of consecutive positive acknowledgment bits being greater than the sum of the first quantity and the second quantity.

In a sixteenth additional aspect, alone or in combination with one or more of the first through fifteenth aspects, process 800 includes receiving an indication to perform HARQ feedback compression, and transmitting the HARQ feedback includes transmitting the HARQ feedback in accordance with the indication to perform HARQ feedback compression.

In a seventeenth additional aspect, alone or in combination with one or more of the first through sixteenth aspects, the indication to perform the HARQ feedback compression includes an indication of a HARQ feedback compression scheme.

In an eighteenth additional aspect, alone or in combination with one or more of the first through seventeenth aspects, the indication to perform the HARQ feedback compression includes an indication of one or more HARQ feedback compression parameters.

In a nineteenth additional aspect, alone or in combination with one or more of the first through eighteenth aspects, process 800 includes transmitting an indication of a UE capability of HARQ feedback compression.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, at a network node or an apparatus of a network node that supports HARQ feedback that includes information regarding a quantity and location of consecutive HARQ bits in accordance with the present disclosure. Example process 900 is an example where the apparatus or the network node (for example, network node 110) performs operations associated with HARQ feedback that includes information regarding a quantity and location of consecutive HARQ bits.

As shown in FIG. 9, in some aspects, process 900 may include transmitting one or more downlink communications (block 910). For example, the network node (such as by using communication manager 155 or transmission component 1104, depicted in FIG. 11) may transmit one or more downlink communications, as described above.

As further shown in FIG. 9, in some aspects, process 900 may include receiving, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence (block 920). For example, the network node (such as by using communication manager 155 or reception component 1102, depicted in FIG. 11) may receive, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence, as described above.

Process 900 may include additional aspects, such as any single aspect or any combination of aspects described below or in connection with one or more other processes described elsewhere herein.

In a first additional aspect, the location of the consecutive positive acknowledgment bits includes a MSB of the HARQ feedback bit sequence or a LSB of the HARQ feedback bit sequence.

In a second additional aspect, alone or in combination with the first aspect, the indication of the quantity of the consecutive positive acknowledgment bits and the location of the consecutive positive acknowledgment bits includes a single bit of the HARQ feedback that indicates whether the location of the consecutive positive acknowledgment bits includes the MSB or the LSB.

In a third additional aspect, alone or in combination with one or more of the first and second aspects, one or more bits within the HARQ feedback bit sequence that are not included in the consecutive positive acknowledgment bits are associated with one or more negative acknowledgments.

In a fourth additional aspect, alone or in combination with one or more of the first through third aspects, the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a MSB of the HARQ feedback bit sequence, and the indication is further of a second quantity of second consecutive positive acknowledgment bits within the HARQ feedback bit sequence and a second location of the second consecutive positive acknowledgment bits within the HARQ feedback bit sequence that includes a LSB of the HARQ feedback bit sequence.

In a fifth additional aspect, alone or in combination with one or more of the first through fourth aspects, the indication is an RIV that indicates a quantity of intermediate bits between the first consecutive positive acknowledgment bits and the second consecutive positive acknowledgment bits and a location of the intermediate bits.

In a sixth additional aspect, alone or in combination with one or more of the first through fifth aspects, one or more bits within the HARQ feedback bit sequence that are not included in the first consecutive positive acknowledgment bits or the second consecutive positive acknowledgment bits are associated with one or more negative acknowledgments.

In a seventh additional aspect, alone or in combination with one or more of the first through sixth aspects, the quantity of the consecutive positive acknowledgment bits is a longest quantity of consecutive positive acknowledgment bits within the HARQ feedback bit sequence.

In an eighth additional aspect, alone or in combination with one or more of the first through seventh aspects, the indication is an RIV that indicates the quantity of the consecutive positive acknowledgment bits and the location of the consecutive positive acknowledgment bits.

In a ninth additional aspect, alone or in combination with one or more of the first through eighth aspects, one or more bits within the HARQ feedback bit sequence that are not included in the consecutive positive acknowledgment bits are associated with one or more negative acknowledgments.

In a tenth additional aspect, alone or in combination with one or more of the first through ninth aspects, the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a MSB of the HARQ feedback bit sequence, and the indication is further of a second quantity of second consecutive positive acknowledgment bits within the HARQ feedback bit sequence and a second location of the second consecutive positive acknowledgment bits within the HARQ feedback bit sequence that includes a LSB of the HARQ feedback bit sequence, in accordance with a sum of the first quantity and the second quantity being greater than or equal to a longest quantity of consecutive positive acknowledgment bits within the HARQ feedback bit sequence.

In an eleventh additional aspect, alone or in combination with one or more of the first through tenth aspects, the indication is an RIV that indicates a quantity of intermediate bits between the first consecutive positive acknowledgment bits and the second consecutive positive acknowledgment bits and a location of the intermediate bits in accordance with the sum of the first quantity and the second quantity being greater than or equal to the longest quantity of consecutive positive acknowledgment bits.

In a twelfth additional aspect, alone or in combination with one or more of the first through eleventh aspects, one or more bits within the HARQ feedback bit sequence that are not included in the first consecutive positive acknowledgment bits or the second consecutive positive acknowledgment bits are associated with one or more negative acknowledgments in accordance with the sum of the first quantity and the second quantity being greater than or equal to the longest quantity of consecutive positive acknowledgment bits.

In a thirteenth additional aspect, alone or in combination with one or more of the first through twelfth aspects, the quantity of the consecutive positive acknowledgment bits is a longest quantity of consecutive positive acknowledgment bits in accordance with the longest quantity of consecutive positive acknowledgment bits within the HARQ feedback bit sequence being greater than a sum of a first quantity of first consecutive positive acknowledgment bits within the HARQ feedback bit sequence having a location including a MSB of the HARQ feedback bit sequence and a second quantity of second consecutive positive acknowledgment bits within the HARQ feedback bit sequence having a location including a LSB of the HARQ feedback bit sequence.

In a fourteenth additional aspect, alone or in combination with one or more of the first through thirteenth aspects, the indication is an RIV that indicates the longest quantity of the consecutive positive acknowledgment bits and the location of the consecutive positive acknowledgment bits in accordance with the longest quantity of consecutive positive acknowledgment bits being greater than the sum of the first quantity and the second quantity.

In a fifteenth additional aspect, alone or in combination with one or more of the first through fourteenth aspects, one or more bits within the HARQ feedback bit sequence that are not included in the consecutive positive acknowledgment bits are associated with one or more negative acknowledgments in accordance with the longest quantity of consecutive positive acknowledgment bits being greater than the sum of the first quantity and the second quantity.

In a sixteenth additional aspect, alone or in combination with one or more of the first through fifteenth aspects, process 900 includes transmitting an indication to perform HARQ feedback compression, and receiving the HARQ feedback includes receiving the HARQ feedback in accordance with the indication to perform HARQ feedback compression.

In a seventeenth additional aspect, alone or in combination with one or more of the first through sixteenth aspects, process 900 includes receiving an indication of a UE capability of HARQ feedback compression.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports HARQ feedback that includes information regarding a quantity and location of consecutive HARQ bits in accordance with the present disclosure. The apparatus 1000 may be a UE, or a UE may include the apparatus 1000. In some aspects, the apparatus 1000 includes a reception component 1002, a transmission component 1004, and a communication manager 1006, which may be in communication with one another (for example, via one or more buses). As shown, the apparatus 1000 may communicate with another apparatus 1008 (such as a UE 120, a network node 110, or another wireless communication device) using the reception component 1002 and the transmission component 1004. The communication manager 1006 may be included in, or implemented via, a processing system (for example, the processing system 140). In some aspects, the communication manager 1006 is the communication manager 150.

In some aspects, the apparatus 1000 may be configured to and/or operable to perform one or more operations described herein in connection with FIGS. 3-7. Additionally or alternatively, the apparatus 1000 may be configured to and/or operable to perform one or more processes described herein, such as process 800 of FIG. 8.

The reception component 1002 may receive communications, such as reference signals, control information, and/or data communications, from the apparatus 1008. The reception component 1002 may provide received communications to one or more other components of the apparatus 1000, such as the communication manager 1006. In some aspects, the reception component 1002 may perform signal processing on the received communications, and may provide the processed signals to the one or more other components in a similar manner as described above in connection with FIG. 1. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, and/or data communications, to the apparatus 1008. In some aspects, the communication manager 1006 may generate communications and may transmit the generated communications to the transmission component 1004 for transmission to the apparatus 1008. In some aspects, the transmission component 1004 may perform signal processing on the generated communications, and may transmit the processed signals to the apparatus 1008 in a similar manner as described above in connection with FIG. 1. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE. In some aspects, the transmission component 1004 may be co-located with the reception component 1002.

The communication manager 1006 may receive or may cause the reception component 1002 to receive one or more downlink communications. The communication manager 1006 may transmit or may cause the transmission component 1004 to transmit, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. In some aspects, the communication manager 1006 may perform one or more operations described elsewhere herein as being performed by one or more components of the communication manager 1006.

In some aspects, the reception component 1002 may receive one or more downlink communications. In some aspects, the transmission component 1004 may transmit, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. In some aspects, the reception component 1002 may receive an indication to perform HARQ feedback compression, wherein transmitting the HARQ feedback includes transmitting the HARQ feedback in accordance with the indication to perform HARQ feedback compression. In some aspects, the transmission component 1004 may transmit an indication of a UE capability of HARQ feedback compression.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication that supports HARQ feedback that includes information regarding a quantity and location of consecutive HARQ bits in accordance with the present disclosure. The apparatus 1100 may be a network node, or a network node may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 145). In some aspects, the communication manager 1106 is the communication manager 155.

In some aspects, the apparatus 1100 may be configured to and/or operable to perform one or more operations described herein in connection with FIGS. 3-7. Additionally or alternatively, the apparatus 1100 may be configured to and/or operable to perform one or more processes described herein, such as process 900 of FIG. 9.

The reception component 1102 may receive communications, such as reference signals, control information, and/or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the network node described above in connection with FIG. 1, such as a radio, one or more RF chains, one or more transceivers, or one or more modems, each of which may in turn be coupled with one or more antennas of the network node.

The transmission component 1104 may transmit communications, such as reference signals, control information, and/or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node. In some aspects, the transmission component 1104 may be co-located with the reception component 1102.

The communication manager 1106 may transmit or may cause the transmission component 1104 to transmit one or more downlink communications. The communication manager 1106 may receive or may cause the reception component 1102 to receive, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. In some aspects, the communication manager 1106 may perform one or more operations described elsewhere herein as being performed by one or more components of the communication manager 1106.

The transmission component 1104 may transmit one or more downlink communications. The reception component 1102 may receive, responsive to the one or more downlink communications, HARQ feedback that includes an indication of a quantity of consecutive positive acknowledgment bits within a HARQ feedback bit sequence and a location of the consecutive positive acknowledgment bits within the HARQ feedback bit sequence. In some aspects, transmission component 1104 may transmit an indication to perform HARQ feedback compression, wherein receiving the HARQ feedback includes receiving the HARQ feedback in accordance with the indication to perform HARQ feedback compression. In some aspects, reception component 1102 may receive an indication of a UE capability of HARQ feedback compression.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed at a user equipment (UE), comprising: receiving one or more downlink communications; and transmitting, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

Aspect 2: The method of Aspect 1, wherein the location of the consecutive positive acknowledgment bits includes a most significant bit (MSB) of the HARQ feedback bit sequence or a least significant bit (LSB) of the HARQ feedback bit sequence.

Aspect 3: The method of Aspect 2, wherein the indication of the quantity of the consecutive positive acknowledgment bits and the location of the consecutive positive acknowledgment bits includes a single bit of the HARQ feedback that indicates whether the location of the consecutive positive acknowledgment bits includes the MSB or the LSB.

Aspect 4: The method of Aspect 2, wherein one or more bits within the HARQ feedback bit sequence that are not included in the consecutive positive acknowledgment bits are associated with one or more negative acknowledgments.

Aspect 5: The method of any of Aspects 1-4, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence.

Aspect 6: The method of Aspect 5, wherein the indication is a resource indication value (RIV) that indicates a quantity of intermediate bits between the first consecutive positive acknowledgment bits and the second consecutive positive acknowledgment bits and a location of the intermediate bits.

Aspect 7: The method of Aspect 5, wherein one or more bits within the HARQ feedback bit sequence that are not included in the first consecutive positive acknowledgment bits or the second consecutive positive acknowledgment bits are associated with one or more negative acknowledgments.

Aspect 8: The method of any of Aspects 1-7, wherein the quantity of the consecutive positive acknowledgment bits is a longest quantity of consecutive positive acknowledgment bits within the HARQ feedback bit sequence.

Aspect 9: The method of Aspect 8, wherein the indication is a resource indication value (RIV) that indicates the quantity of the consecutive positive acknowledgment bits and the location of the consecutive positive acknowledgment bits.

Aspect 10: The method of Aspect 8, wherein one or more bits within the HARQ feedback bit sequence that are not included in the consecutive positive acknowledgment bits are associated with one or more negative acknowledgments.

Aspect 11: The method of any of Aspects 1-10, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence, in accordance with a sum of the first quantity and the second quantity being greater than or equal to a longest quantity of consecutive positive acknowledgment bits within the HARQ feedback bit sequence.

Aspect 12: The method of Aspect 11, wherein the indication is a resource indication value (RIV) that indicates a quantity of intermediate bits between the first consecutive positive acknowledgment bits and the second consecutive positive acknowledgment bits and a location of the intermediate bits in accordance with the sum of the first quantity and the second quantity being greater than or equal to the longest quantity of consecutive positive acknowledgment bits.

Aspect 13: The method of Aspect 11, wherein one or more bits within the HARQ feedback bit sequence that are not included in the first consecutive positive acknowledgment bits or the second consecutive positive acknowledgment bits are associated with one or more negative acknowledgments in accordance with the sum of the first quantity and the second quantity being greater than or equal to the longest quantity of consecutive positive acknowledgment bits.

Aspect 14: The method of any of Aspects 1-13, wherein the quantity of the consecutive positive acknowledgment bits is a longest quantity of consecutive positive acknowledgment bits in accordance with the longest quantity of consecutive positive acknowledgment bits within the HARQ feedback bit sequence being greater than a sum of a first quantity of first consecutive positive acknowledgment bits within the HARQ feedback bit sequence having a location including a most significant bit (MSB) of the HARQ feedback bit sequence and a second quantity of second consecutive positive acknowledgment bits within the HARQ feedback bit sequence having a location including a least significant bit (LSB) of the HARQ feedback bit sequence.

Aspect 15: The method of Aspect 14, wherein the indication is a resource indication value (RIV) that indicates the longest quantity of the consecutive positive acknowledgment bits and the location of the consecutive positive acknowledgment bits in accordance with the longest quantity of consecutive positive acknowledgment bits being greater than the sum of the first quantity and the second quantity.

Aspect 16: The method of Aspect 14, wherein one or more bits within the HARQ feedback bit sequence that are not included in the consecutive positive acknowledgment bits are associated with one or more negative acknowledgments in accordance with the longest quantity of consecutive positive acknowledgment bits being greater than the sum of the first quantity and the second quantity.

Aspect 17: The method of any of Aspects 1-16, further comprising: receiving an indication to perform HARQ feedback compression, wherein transmitting the HARQ feedback includes transmitting the HARQ feedback in accordance with the indication to perform HARQ feedback compression.

Aspect 18: The method of Aspect 17, wherein the indication to perform the HARQ feedback compression includes an indication of a HARQ feedback compression scheme.

Aspect 19: The method of Aspect 17, wherein the indication to perform the HARQ feedback compression includes an indication of one or more HARQ feedback compression parameters.

Aspect 20: The method of any of Aspects 1-19, further comprising: transmitting an indication of a UE capability of HARQ feedback compression.

Aspect 21: A method of wireless communication performed at a network node, comprising: transmitting one or more downlink communications; and receiving, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

Aspect 22: The method of Aspect 21, wherein the location of the consecutive positive acknowledgment bits includes a most significant bit (MSB) of the HARQ feedback bit sequence or a least significant bit (LSB) of the HARQ feedback bit sequence.

Aspect 23: The method of Aspect 22, wherein the indication of the quantity of the consecutive positive acknowledgment bits and the location of the consecutive positive acknowledgment bits includes a single bit of the HARQ feedback that indicates whether the location of the consecutive positive acknowledgment bits includes the MSB or the LSB.

Aspect 24: The method of Aspect 22, wherein one or more bits within the HARQ feedback bit sequence that are not included in the consecutive positive acknowledgment bits are associated with one or more negative acknowledgments.

Aspect 25: The method of any of Aspects 21-24, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence.

Aspect 26: The method of Aspect 25, wherein the indication is a resource indication value (RIV) that indicates a quantity of intermediate bits between the first consecutive positive acknowledgment bits and the second consecutive positive acknowledgment bits and a location of the intermediate bits.

Aspect 27: The method of Aspect 25, wherein one or more bits within the HARQ feedback bit sequence that are not included in the first consecutive positive acknowledgment bits or the second consecutive positive acknowledgment bits are associated with one or more negative acknowledgments.

Aspect 28: The method of any of Aspects 21-27, wherein the quantity of the consecutive positive acknowledgment bits is a longest quantity of consecutive positive acknowledgment bits within the HARQ feedback bit sequence.

Aspect 29: The method of Aspect 28, wherein the indication is a resource indication value (RIV) that indicates the quantity of the consecutive positive acknowledgment bits and the location of the consecutive positive acknowledgment bits.

Aspect 30: The method of Aspect 28, wherein one or more bits within the HARQ feedback bit sequence that are not included in the consecutive positive acknowledgment bits are associated with one or more negative acknowledgments.

Aspect 31: The method of any of Aspects 21-30, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence, in accordance with a sum of the first quantity and the second quantity being greater than or equal to a longest quantity of consecutive positive acknowledgment bits within the HARQ feedback bit sequence.

Aspect 32: The method of Aspect 31, wherein the indication is a resource indication value (RIV) that indicates a quantity of intermediate bits between the first consecutive positive acknowledgment bits and the second consecutive positive acknowledgment bits and a location of the intermediate bits in accordance with the sum of the first quantity and the second quantity being greater than or equal to the longest quantity of consecutive positive acknowledgment bits.

Aspect 33: The method of Aspect 31, wherein one or more bits within the HARQ feedback bit sequence that are not included in the first consecutive positive acknowledgment bits or the second consecutive positive acknowledgment bits are associated with one or more negative acknowledgments in accordance with the sum of the first quantity and the second quantity being greater than or equal to the longest quantity of consecutive positive acknowledgment bits.

Aspect 34: The method of any of Aspects 21-33, wherein the quantity of the consecutive positive acknowledgment bits is a longest quantity of consecutive positive acknowledgment bits in accordance with the longest quantity of consecutive positive acknowledgment bits within the HARQ feedback bit sequence being greater than a sum of a first quantity of first consecutive positive acknowledgment bits within the HARQ feedback bit sequence having a location including a most significant bit (MSB) of the HARQ feedback bit sequence and a second quantity of second consecutive positive acknowledgment bits within the HARQ feedback bit sequence having a location including a least significant bit (LSB) of the HARQ feedback bit sequence.

Aspect 35: The method of Aspect 34, wherein the indication is a resource indication value (RIV) that indicates the longest quantity of the consecutive positive acknowledgment bits and the location of the consecutive positive acknowledgment bits in accordance with the longest quantity of consecutive positive acknowledgment bits being greater than the sum of the first quantity and the second quantity.

Aspect 36: The method of Aspect 34, wherein one or more bits within the HARQ feedback bit sequence that are not included in the consecutive positive acknowledgment bits are associated with one or more negative acknowledgments in accordance with the longest quantity of consecutive positive acknowledgment bits being greater than the sum of the first quantity and the second quantity.

Aspect 37: The method of any of Aspects 21-36, further comprising: transmitting an indication to perform HARQ feedback compression, wherein receiving the HARQ feedback includes receiving the HARQ feedback in accordance with the indication to perform HARQ feedback compression.

Aspect 38: The method of Aspect 37, wherein the indication to perform the HARQ feedback compression includes an indication of a HARQ feedback compression scheme.

Aspect 39: The method of Aspect 37, wherein the indication to perform the HARQ feedback compression includes an indication of one or more HARQ feedback compression parameters.

Aspect 40: The method of any of Aspects 21-39, further comprising: receiving an indication of a UE capability of HARQ feedback compression.

Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.

Aspect 42: An apparatus for wireless communication at a device, the apparatus comprising one or more memories and one or more processors coupled to the one or more memories, the one or more processors configured to cause the device to perform the method of one or more of Aspects 1-40.

Aspect 43: An apparatus for wireless communication, the apparatus comprising at least one means for performing the method of one or more of Aspects 1-40.

Aspect 44: A non-transitory computer-readable medium storing code for wireless communication, the code comprising instructions executable by one or more processors to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

Aspect 46: A device for wireless communication, the device comprising a processing system that includes one or more processors and one or more memories coupled with the one or more processors, the processing system configured to cause the device to perform the method of one or more of Aspects 1-40.

Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive one or more downlink communications; and
transmit, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

2. The apparatus of claim 1, wherein the location of the consecutive positive acknowledgment bits includes a most significant bit (MSB) of the HARQ feedback bit sequence or a least significant bit (LSB) of the HARQ feedback bit sequence.

3. The apparatus of claim 2, wherein the indication of the quantity of the consecutive positive acknowledgment bits and the location of the consecutive positive acknowledgment bits includes a single bit of the HARQ feedback that indicates whether the location of the consecutive positive acknowledgment bits includes the MSB or the LSB.

4. The apparatus of claim 1, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence.

5. The apparatus of claim 4, wherein the indication is a resource indication value (RIV) that indicates a quantity of intermediate bits between the first consecutive positive acknowledgment bits and the second consecutive positive acknowledgment bits and a location of the intermediate bits.

6. The apparatus of claim 1, wherein the quantity of the consecutive positive acknowledgment bits is a longest quantity of consecutive positive acknowledgment bits within the HARQ feedback bit sequence.

7. The apparatus of claim 6, wherein the indication is a resource indication value (RIV) that indicates the quantity of the consecutive positive acknowledgment bits and the location of the consecutive positive acknowledgment bits.

8. The apparatus of claim 1, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence, in accordance with a sum of the first quantity and the second quantity being greater than or equal to a longest quantity of consecutive positive acknowledgment bits within the HARQ feedback bit sequence.

9. The apparatus of claim 8, wherein the indication is a resource indication value (RIV) that indicates a quantity of intermediate bits between the first consecutive positive acknowledgment bits and the second consecutive positive acknowledgment bits and a location of the intermediate bits in accordance with the sum of the first quantity and the second quantity being greater than or equal to the longest quantity of consecutive positive acknowledgment bits.

10. The apparatus of claim 1, wherein the quantity of the consecutive positive acknowledgment bits is a longest quantity of consecutive positive acknowledgment bits in accordance with the longest quantity of consecutive positive acknowledgment bits within the HARQ feedback bit sequence being greater than a sum of a first quantity of first consecutive positive acknowledgment bits within the HARQ feedback bit sequence having a location including a most significant bit (MSB) of the HARQ feedback bit sequence and a second quantity of second consecutive positive acknowledgment bits within the HARQ feedback bit sequence having a location including a least significant bit (LSB) of the HARQ feedback bit sequence.

11. The apparatus of claim 10, wherein the indication is a resource indication value (RIV) that indicates the longest quantity of the consecutive positive acknowledgment bits and the location of the consecutive positive acknowledgment bits in accordance with the longest quantity of consecutive positive acknowledgment bits being greater than the sum of the first quantity and the second quantity.

12. The apparatus of claim 1, wherein at least one processor of the one or more processors is further configured to cause the UE to:
receive an indication to perform HARQ feedback compression, wherein
transmitting the HARQ feedback includes transmitting the HARQ feedback in accordance with the indication to perform HARQ feedback compression.

13. The apparatus of claim 12, wherein the indication to perform the HARQ feedback compression includes an indication of a HARQ feedback compression scheme.

14. The apparatus of claim 12, wherein the indication to perform the HARQ feedback compression includes an indication of one or more HARQ feedback compression parameters.

15. An apparatus for wireless communication at a network node, comprising:
one or more memories storing processor-executable code; and
one or more processors coupled with the one or more memories, at least one processor of the one or more processors configured to cause the network node to:
transmit one or more downlink communications; and
receive, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

16. The apparatus of claim 15, wherein the location of the consecutive positive acknowledgment bits includes a most significant bit (MSB) of the HARQ feedback bit sequence or a least significant bit (LSB) of the HARQ feedback bit sequence.

17. The apparatus of claim 16, wherein one or more bits within the HARQ feedback bit sequence that are not included in the consecutive positive acknowledgment bits are associated with one or more negative acknowledgments.

18. The apparatus of claim 15, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence.

19. The apparatus of claim 18, wherein one or more bits within the HARQ feedback bit sequence that are not included in the first consecutive positive acknowledgment bits or the second consecutive positive acknowledgment bits are associated with one or more negative acknowledgments.

20. The apparatus of claim 15, wherein the quantity of the consecutive positive acknowledgment bits is a longest quantity of consecutive positive acknowledgment bits within the HARQ feedback bit sequence.

21. The apparatus of claim 20, wherein one or more bits within the HARQ feedback bit sequence that are not included in the consecutive positive acknowledgment bits are associated with one or more negative acknowledgments.

22. The apparatus of claim 15, wherein the consecutive positive acknowledgment bits are first consecutive positive acknowledgment bits, the quantity of the first consecutive positive acknowledgment bits is a first quantity of the first consecutive positive acknowledgment bits, the location of the first consecutive positive acknowledgment bits is a first location of the first consecutive positive acknowledgment bits that includes a most significant bit (MSB) of the HARQ feedback bit sequence, and wherein the indication is further of a second quantity of second consecutive positive acknowledgment bits within the HARQ feedback bit sequence and a second location of the second consecutive positive acknowledgment bits within the HARQ feedback bit sequence that includes a least significant bit (LSB) of the HARQ feedback bit sequence, in accordance with a sum of the first quantity and the second quantity being greater than or equal to a longest quantity of consecutive positive acknowledgment bits within the HARQ feedback bit sequence.

23. The apparatus of claim 22, wherein one or more bits within the HARQ feedback bit sequence that are not included in the first consecutive positive acknowledgment bits or the second consecutive positive acknowledgment bits are associated with one or more negative acknowledgments in accordance with the sum of the first quantity and the second quantity being greater than or equal to the longest quantity of consecutive positive acknowledgment bits.

24. The apparatus of claim 15, wherein the quantity of the consecutive positive acknowledgment bits is a longest quantity of consecutive positive acknowledgment bits in accordance with the longest quantity of consecutive positive acknowledgment bits within the HARQ feedback bit sequence being greater than a sum of a first quantity of first consecutive positive acknowledgment bits within the HARQ feedback bit sequence having a location including a most significant bit (MSB) of the HARQ feedback bit sequence and a second quantity of second consecutive positive acknowledgment bits within the HARQ feedback bit sequence having a location including a least significant bit (LSB) of the HARQ feedback bit sequence.

25. The apparatus of claim 24, wherein one or more bits within the HARQ feedback bit sequence that are not included in the consecutive positive acknowledgment bits are associated with one or more negative acknowledgments in accordance with the longest quantity of consecutive positive acknowledgment bits being greater than the sum of the first quantity and the second quantity.

26. The apparatus of claim 15, wherein at least one processor of the one or more processors is further configured to cause the network node to:
receive an indication of a UE capability of HARQ feedback compression.

27. A method of wireless communication performed at a user equipment (UE), comprising:
receiving one or more downlink communications; and
transmitting, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

28. The method of claim 27, further comprising:
transmitting an indication of a UE capability of HARQ feedback compression.

29. A method of wireless communication performed at a network node, comprising:
transmitting one or more downlink communications; and
receiving, responsive to the one or more downlink communications, hybrid automatic repeat request (HARQ) feedback that includes an indication of a quantity of consecutive positive acknowledgment bits within a HARQ feedback bit sequence and a location of the consecutive positive acknowledgment bits within the HARQ feedback bit sequence.

30. The method of claim 29, further comprising:
transmitting an indication to perform HARQ feedback compression, wherein receiving the HARQ feedback includes receiving the HARQ feedback in accordance with the indication to perform HARQ feedback compression.
